(19) United States
(12) Patent Application Publication
(10) Pub. No.: US 2022/0022484 A1
(43) Pub. Date: Jan. 27, 2022

(54) CUP AND STIRRING ELEMENT FOR A DEVICE FOR PREPARING A FROZEN FOOD PRODUCT FROM A LIQUID MIXTURE AND THE DEVICE

(71) Applicant: Frederik Van Isacker, Zaventem (BE)

(72) Inventor: Frederik Van Isacker, Zaventem (BE)

(73) Assignee: KEMPISCHE BRIK CENTRALE, Zaventem (BE)

(21) Appl. No.: 17/021,810

(22) Filed: Sep. 15, 2020

Related U.S. Application Data
(63) Continuation of application No. PCT/EP2020/070861, filed on Jul. 23, 2020.

(51) Int. Cl. A23G 9/12; A23G 9/22; A23G 9/16

(52) U.S. Cl. CPC A23G 9/12; A23G 9/16; A23G 9/224

(57) ABSTRACT

A cup is provided for a device for preparing a frozen food product from a liquid mixture with a stirring element stirring liquid mixture in the cup being cooled by a cooling unit of the device. The cup includes a cup wall enclosing a holding volume for liquid mixture and frozen food product. At the inside of the cup, the cup wall includes an inner bottom portion, a circumferential inner upright portion, and a circumferential inner transition portion extending from the inner bottom portion to the inner upright portion.

### TECHNICAL FIELD

The present disclosure relates to a cup for a device for preparing a frozen food product, such as for example ice cream or sorbet, from a liquid mixture, preferably in individual portions. The present disclosure also relates to a stirring element for a device for preparing a frozen food product from a liquid mixture. The present disclosure also relates to a device for preparing a frozen food product from a liquid mixture.

### BACKGROUND

US 2017/0225879 A1 and WO 2015/169841 A1 both show a removable cup or container for a device for preparing a frozen food product from a liquid mixture in individual portions. The cups, when received in a cavity of a cup holder of the device, are used for preparing the frozen food product therein from the liquid mixture by a stirring element of the device stirring the liquid mixture in the cup while the cup is being cooled by a cooling unit of the device. These cups comprise a cup wall enclosing a holding volume for the liquid mixture and the frozen food product. The cup wall comprises a bottom portion, a circumferential upright portion, and a circumferential transition portion extending from the bottom portion to the upright portion. At the inside of the cup, the bottom portion, the upright portion and the transition portion are cylindrically symmetric around a central axis. The upright portion of the cup wall is inclined outwards in a transverse or radial direction from the height direction with a certain inclination angle, and an upright portion of an inner wall of the cavity of the cup holder of the device is inclined from the height direction with the same inclination angle, which makes it easy to remove the cup from the cavity when the frozen food product has been prepared.

These cups have however the disadvantage that the shape and dimensions of the transition portion of the cup wall at the inside of the cup make it difficult to scoop all the frozen food product out of the cup with a spoon.

These cups also have the disadvantage that, because of the upright portion of the cup wall at the inside of the cup being inclined outwards, liquid mixture and frozen food product sometimes spills out of the cup when the frozen food product is being prepared in the cup by stirring the liquid mixture in the cup by the stirring element.

### SUMMARY

It is an aim of the present disclosure to provide a cup and a stirring element for a device for preparing a frozen food product from a liquid mixture, wherein the liquid mixture and the frozen food product does not spill out of the cup when the frozen food product is being prepared in the cup by stirring the liquid mixture in the cup by the stirring element, and wherein the frozen food product is easy to scoop out of the cup with a spoon.

The aim of the present disclosure, or others, is achieved with a cup showing the technical characteristics of the first independent claim, and with a stirring element showing the technical characteristics of the second independent claim.

Therefore, the present disclosure provides a cup or container for a device for preparing a frozen food product, such as for example ice cream or sorbet, from a liquid mixture. In some embodiments, the cup is arranged for preparing the frozen food product therein from the liquid mixture by a stirring element of the device stirring the liquid mixture in the cup while the cup is being cooled by a cooling unit of the device. In some embodiments, the stirring element is the stirring element according to the present disclosure as described below. The cup comprises a cup wall enclosing a holding volume for the liquid mixture and the frozen food product. In some embodiments, the cup comprises a top opening to the holding volume. At the inside of the cup, the cup wall comprises an inner bottom portion, a circumferential inner upright portion, and a circumferential inner transition portion extending from the inner bottom portion to the inner upright portion. The inner bottom portion, the inner upright portion and the inner transition portion are cylindrically symmetric around a first axis centrally through the inner bottom portion and extending along a height direction. The inner transition portion has in the height direction a radius of curvature of at least 15 mm, preferably at least 16 mm, more preferably at least 17 mm, even more preferably at least 18 mm, and yet even more preferably at least 19 mm. The inner transition portion has in the height direction a radius of curvature of at most 25 mm, preferably at most 24 mm, more preferably at most 23 mm, even more preferably at most 22 mm, and yet even more preferably at most 21 mm. The inner upright portion is inclined outwards in a transverse or radial direction from the height direction. The inner upright portion has with respect to the height direction a predetermined inclination angle of at least 10, preferably at least 2°, more preferably at least 30, and even more preferably at least 4°. The inner upright portion has with respect to the height direction a predetermined inclination angle of at most 9°, preferably at most 8°, more preferably at most 7°, and even more preferably at most 6°. Most preferably, the inner upright portion has with respect to the height direction a predetermined inclination angle of 5°. Preferably, the cup wall comprises, at the outside of the cup, a circumferential outer upright portion which has with respect to the height direction an inclination corresponding to the inclination angle of the inner upright portion of the cup wall at the inside of the cup.

The cup of the present disclosure offers the advantage that the curvature of the inner transition portion is adapted more to the curvature of the sides of a spoon, such that it becomes easier to scoop frozen food product from the inner transition portion by a spoon.

The inventors have however found that adapting the curvature of the inner transition portion in cups known from the prior art in this way increases the risk of liquid mixture and frozen food product spilling out of the cup when the frozen food product is being prepared in the cup by stirring the liquid mixture in the cup by a stirring element. With respect to this problem the cup of the present disclosure offers the advantage that the inner upright portion having the predetermined inclination angle with respect to the height directions aids in keeping liquid mixture and the frozen food product in the cup while the frozen food product is being prepared in the cup by stirring the liquid mixture in the cup by the stirring element.

Providing the outer upright portion of the cup wall with the same inclination angle as the inner upright portion of the cup wall offers the advantage that the cup wall can be made as thin as possible to provide a good heat transfer from the cup to the cooling unit of the device for cooling the cup, and also offers the advantage that the cup can be easily removed from a correspondingly shaped cavity of the device for preparing a frozen food product from a liquid mixture in which the cup has been received.

In an embodiment of the cup according to the present disclosure the inner bottom portion is flat.

The flat inner bottom portion offers the advantage that it provides a simple surface from which food product can easily be scooped by a spoon, and from which the stirring element of the device for preparing the frozen food product from the liquid mixture can easily scrape frozen liquid mixture when stirring the liquid mixture in the cup for preparing the frozen food product.

In an embodiment of the cup according to the present disclosure the inner bottom portion has a predetermined radius of at least 16 mm, preferably at least 17 mm, more preferably at least 18 mm, even more preferably at least 19 mm, and yet even more preferably at least 20 mm. The inner bottom portion has a predetermined radius of at most 26 mm, preferably at most 25 mm, more preferably at most 24 mm, even more preferably at most 23 mm, and yet even more preferably at most 22 mm. In some embodiments, the inner bottom portion is flat.

This embodiment is beneficial for providing a cup for preparing individual portions of the frozen product therein.

In an embodiment of the cup according to the present disclosure the inner transition portion is in the height direction one of an elliptic arc, a circular arc and a parabolic arc.

This embodiment offers the advantage that the shape of the inner transition portion is adapted more to the shape of the sides of a spoon, such that it becomes easier to scoop frozen food product from the inner transition portion by a spoon.

In an embodiment of the cup according to the present disclosure the inner transition portion extends in the transverse direction over a predetermined first distance of at least 15 mm, preferably at least 16 mm, more preferably at least 17 mm, even more preferably at least 18 mm, and yet even more preferably at least 19 mm. The inner transition portion extends in the transverse direction over a predetermined first distance of at most 25 mm, preferably at most 24 mm, more preferably at most 23 mm, even more preferably at most 22 mm, and yet even more preferably at most 21 mm.

This embodiment offers the advantage that a large inner transition portion is provided, which corresponds more to the size of a spoon, such that it becomes even more easy to scoop frozen food product from the inner transition portion by a spoon. This embodiment is also beneficial for providing a cup for preparing individual portions of the frozen product therein.

In an embodiment of the cup according to the present disclosure the inner transition portion extends in the height direction over a predetermined second distance of at least 15 mm, preferably at least 16 mm, more preferably at least 17 mm, even more preferably at least 18 mm, and yet even more preferably at least 19 mm. The inner transition portion extends in the height direction over a predetermined second distance of at most 25 mm, preferably at most 24 mm, more preferably at most 23 mm, even more preferably at most 22 mm, and yet even more preferably at most 21 mm.

This embodiment offers the advantage that a large inner transition portion is provided, which corresponds more to the size of a spoon, such that it becomes even more easy to scoop frozen food product from the inner transition portion by a spoon. This embodiment is also beneficial for providing a cup for preparing individual portions of the frozen product therein.

In an embodiment of the cup according to the present disclosure the inner upright portion extends in the height direction over a predetermined third distance of at least 32 mm, preferably at least 33 mm, more preferably at least 34 mm, even more preferably at least 35 mm, and yet even more preferably at least 36 mm. The inner upright portion extends in the height direction over a predetermined third distance of at most 42 mm, preferably at most 41 mm, more preferably at most 40 mm, even more preferably at most 39 mm, and yet even more preferably at most 38 mm.

The inner upright portion extending in the height direction over the predetermined third distance is beneficial for keeping liquid mixture and the frozen food product in the cup while the frozen food product is being prepared in the cup by stirring the liquid mixture in the cup by the stirring element. This embodiment is also beneficial for providing a cup for preparing individual portions of the frozen product therein.

In an embodiment of the cup according to the present disclosure the inner upright portion is straight in the height direction.

The inner upright portion being straight in the height direction offers the advantage that it provides a simple surface from which the stirring element of the device for preparing the frozen food product from the liquid mixture can easily scrape frozen liquid mixture when stirring the liquid mixture in the cup for preparing the frozen food product.

The present disclosure further provides a stirring element for a device for preparing a frozen food product, such as for example ice cream or sorbet, from a liquid mixture. In some embodiments, the stirring element is arranged for preparing the frozen food product by stirring the liquid mixture in a cup of the device while the cup is being cooled by a cooling unit of the device. In some embodiments, the stirring element is configured for scraping frozen liquid mixture from the cup wall at the inside of the cup when stirring the liquid mixture in the cup. The stirring element comprises at least one edge side. In some embodiments, the at least one edge side is arranged for contacting at least temporary the cup while stirring the liquid mixture in the cup. The at least one edge side comprises a bottom portion, an upright portion, and a transition portion extending from the bottom portion to the upright portion. The transition portion has a radius of curvature of at least 15 mm, preferably at least 16 mm, more preferably at least 17 mm, even more preferably at least 18 mm, and yet even more preferably at least 19 mm. The transition portion has a radius of curvature of at most 25 mm, preferably at most 24 mm, more preferably at most 23 mm, even more preferably at most 22 mm, and yet even more preferably at most 21 mm. The upright portion is inclined outwards in a transverse direction from the height direction. The upright portion has with respect to the height direction a predetermined inclination angle of at least 10, preferably at least 2°, more preferably at least 3°, and even more preferably, at least 4. The upright portion has with respect to the height direction a predetermined inclination angle of at most 9°, preferably at most 8°, more preferably at most 7°, even more preferably at most 6°. Most preferably, the upright portion has with respect to the height direction a predetermined inclination angle of 5°.

The stirring element according to the present disclosure is intended for use in combination with the cup according to the present disclosure, wherein for stirring the liquid mixture the stirring element is arranged in the cup with the at least one edge side contacting the cup wall at the inside of the cup, such that the stirring element can scrape frozen liquid mixture from the cup wall at the inside of the cup. Therefore, it is beneficial to give the bottom portion, the upright portion and the transition portion of the at least one edge side of the stirring element a shape corresponding respectively to the shape of the inner bottom portion, the inner upright portion and the inner transition portion of the cup wall at the inside of the cup.

In an embodiment of the stirring element according to the present disclosure the bottom portion is flat.

In an embodiment of the stirring element according to the present disclosure the bottom portion has a predetermined width of at least 16 mm, preferably at least 17 mm, more preferably at least 18 mm, even more preferably at least 19 mm, and yet even more preferably at least 20 mm. The bottom portion has a predetermined width of at most 26 mm, preferably at most 25 mm, more preferably at most 24 mm, even more preferably at most 23 mm, and yet even more preferably at most 22 mm. Preferably, the bottom portion is flat.

The bottom portion of the at least one edge side of the stirring element having a predetermined width equal to a predetermined radius of an inner bottom portion of a cup wall of a cup according to an embodiment of the present disclosure, offers the advantage that the stirring element can scrape frozen liquid mixture from the entire inner bottom portion of the cup wall when the stirring element is stirring the liquid mixture in the cup for preparing the frozen food product.

In an embodiment of the stirring element according to the present disclosure the transition portion is in the height direction one of an elliptic arc, a circular arc and a parabolic arc.

In an embodiment of the stirring element according to the present disclosure the transition portion extends in the transverse direction over a predetermined first distance of at least 15 mm, preferably at least 16 mm, more preferably at least 17 mm, even more preferably at least 18 mm, and yet even more preferably at least 19 mm. The transition portion extends in the transverse direction over a predetermined first distance of at most 25 mm, preferably at most 24 mm, more preferably at most 23 mm, even more preferably at most 22 mm, and yet even more preferably at most 21 mm.

In an embodiment of the stirring element according to the present disclosure the transition portion extends in the height direction over a predetermined second distance of at least 15 mm, preferably at least 16 mm, more preferably at least 17 mm, even more preferably at least 18 mm, and yet even more preferably at least 19 mm. The transition portion extends in the height direction over a predetermined second distance of at most 25 mm, preferably at most 24 mm, more preferably at most 23 mm, even more preferably at most 22 mm, and yet even more preferably at most 21 mm.

In an embodiment of the stirring element according to the present disclosure the upright portion extends in the height direction over a predetermined fourth distance of at least 32 mm, preferably at least 33 mm, more preferably at least 34 mm, even more preferably at least 35 mm, and yet even more preferably at least 36 mm. The upright portion extends in the height direction over a predetermined fourth distance of at most 42 mm, preferably at most 41 mm, more preferably at most 40 mm, even more preferably at most 39 mm, and yet even more preferably at most 38 mm.

The upright portion of the at least one edge side of the stirring element extending in the height direction over a predetermined fourth distance, which is preferably approximately equal to a predetermined third distance over which the inner upright portion of a cup wall of a cup according to an embodiment of the present disclosure extends, is beneficial for obtaining a good stirring of the liquid mixture in the cup and for scraping frozen liquid mixture from the entire inner upright portion of the cup wall of the cup.

In an embodiment of the stirring element according to the present disclosure the upright portion is straight.

In an embodiment of the stirring element according to the present disclosure the stirring element comprises a first edge side and a second edge side. The first edge side and the second edge side are arranged opposite of each other in the transverse direction.

In some embodiments, the first edge side and the second edge side have a common bottom portion.

This embodiment is beneficial for providing a stirring element which may simultaneously be in contact with opposing sides of the cup wall at the inside of the cup, in order to be able to scrape frozen liquid mixture from said opposing sides of the cup wall at the inside of the cup while stirring the stirring element in the liquid mixture in the cup for preparing the frozen food product.

This embodiment is also beneficial for providing a stirring element which is to arranged in the cup at a predetermined offset from the first axis with one of the edge sides contacting the cup wall at the inside of the cup. In addition to a rotation around the first axis, this stirring element can then also be rotated around a second axis centrally through the stirring element, such that the opposing edge sides of the stirring element are alternatingly brought into contact with the cup wall at the inside of the cup. This embodiment provides an improved mixing of frozen liquid mixture in the cup for preparing the frozen food product.

In an embodiment of the stirring element according to the present disclosure the stirring element is a stirring paddle.

The present disclosure further provides a device for preparing a frozen food product, such as for example ice cream or sorbet, from a liquid mixture. The device comprises a cup or container according to the present disclosure in which the frozen food product is to be prepared from the liquid mixture. The device comprises a cup holder. The cup holder comprises a cavity receiving the cup. In some embodiments, the cavity is fittingly receiving the cup. In some embodiments, the cup wall has at the outside of the cup a shape complementary to the shape of an inner wall of the cavity. In some embodiments, the cup is removable from the cavity. The device comprises a cooling unit configured for cooling the cavity of the cup holder. The device comprises a stirring unit configured for stirring the liquid mixture in the cup by a stirring element according to the present disclosure for preparing the frozen food product. In some embodiments, the stirring element is configured for scraping frozen liquid mixture from the cup wall at the inside of the cup when stirring the liquid mixture in the cup. The stirring unit comprises a drive system for driving the stirring motion of the stirring element in the cup. In some embodiments, the stirring unit is arranged above the cup holder. In some embodiments, the stirring element is removably connected to the stirring unit.

In an embodiment of the device according to the present disclosure an inner wall of the cavity comprises a circumferential upright portion. The upright portion is inclined outwards in a transverse direction from a height direction. The upright portion has with respect to the height direction a predetermined inclination angle of at least 10, preferably at least 2°, more preferably at least 3°, and even more preferably at least 4°. The upright portion has with respect to the height direction a predetermined inclination angle of at most 9°, preferably at most 8°, more preferably at most 7°, and even more preferably at most 6°. Most preferably, the upright portion has with respect to the height direction a predetermined inclination angle of 5°.

In an embodiment of the device according to the present disclosure the stirring element is arranged with a second axis at a predetermined offset from the first axis. The second axis extends in a height direction. The second axis extends through the stirring element. The drive system is arranged for rotating the stirring element around the first axis and the second axis.

In an embodiment of the device according to the present disclosure the cup holder comprises a first upper surface surrounding an entrance opening of the cavity.

In an embodiment of the device according to the present disclosure the cup holder comprises in a second upper surface a recessed area surrounding the entrance opening of the cavity. A bottom surface of the recessed area forms the first upper surface of the cup holder.

This embodiment offers the advantage that liquid mixture or frozen food product accidentally spilling out of the cup while preparing the frozen food product is contained inside the recessed area, thereby preventing the spilled liquid mixture or frozen food product from further spreading over the device. This makes it easier to clean the device, and is beneficial for hygiene by preventing spilled liquid mixture or frozen food product from being left behind on difficult to clean places of the device.

In an embodiment of the device according to the present disclosure the stirring unit is arranged above the cup holder. The stirring unit comprises a moveable portion. The moveable portion is moveable along a height direction between a first position and a second position. In the first position the stirring element is arranged outside of the cup. In the second position the stirring element is arranged inside the cup for stirring the liquid mixture for preparing the frozen food product. The stirring unit is provided with a protection screen extending downwards from the moveable portion of the stirring unit. The protection screen is arranged such that a bottom edge of the protection screen supports on the first upper surface when the moveable portion of the stirring unit is in the second position. In some embodiments, the protection screen and the recessed area are arranged such that a bottom edge of the protection screen supports on the first upper surface near an edge of the recessed area when the moveable portion of the stirring unit is in the second position.

This embodiment is beneficial for the safety of the device by closing off the area above the cup between the cup holder and the moveable portion of the stirring unit, such that no access to the moving stirring element is possible when the frozen food product is being prepared from the liquid mixture by the stirring element stirring the liquid mixture in the cup while the cup is being cooled by the cooling unit.

In combination with the embodiment of the device having the recessed area in the second upper surface, this embodiment also offers the advantage that the bottom edge of the protection screen supporting on the first upper surface, i.e. the bottom surface of the recessed area, makes it more difficult to grab underneath the protection screen to lift it up and get access to the area above the cup between the cup holder and the moveable portion of the stirring unit while the frozen food product is being prepared. This is beneficial for the safety of the device.

This embodiment also offers the advantage that liquid mixture or frozen food product spilling out of the cup while preparing the frozen food product is contained on the first upper surface by the protection screen, thereby preventing the spilled liquid mixture or frozen food product from further spreading over the device. This makes it easier to clean the device, and is beneficial for hygiene by preventing spilled liquid mixture or frozen food product from being left behind on difficult to clean places of the device.

### DESCRIPTION OF THE DRAWINGS

The disclosed subject matter will be further elucidated by the following description and the appended figures.

FIG. 1A shows a device for preparing a frozen food product from a liquid mixture according to an embodiment of the present disclosure.

FIG. 1B shows the device of FIG. 1A where a protection screen is omitted for illustration purposes.

FIG. 2A shows a cross section through the cup holder of the device of FIG. 1A.

FIG. 2B shows a cross section through the cup holder of the device of FIG. 1A, wherein a cup is received in the cavity of the cup holder.

FIG. 3A shows the drive system of the device of FIG. 1A with a connected stirring element arranged in a cup.

FIG. 3B shows a cross section through the drive system as shown in FIG. 3A.

FIG. 4A shows a perspective view of the stirring element of the device of FIG. 1A.

FIG. 4B shows a front view of the stirring element of the device of FIG. 1A.

FIG. 5A shows a perspective view of a cup according to an embodiment of the present disclosure.

FIG. 5B shows a top view of the cup of FIG. 5A.

FIG. 5C shows a side view of the cup of FIG. 5A.

FIG. 5D shows a cross section of the cup of FIG. 5A with the viewpoint indicated in FIG. 5C.

### DETAILED DESCRIPTION

The present disclosure will be described with respect to particular embodiments and with reference to certain drawings, but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

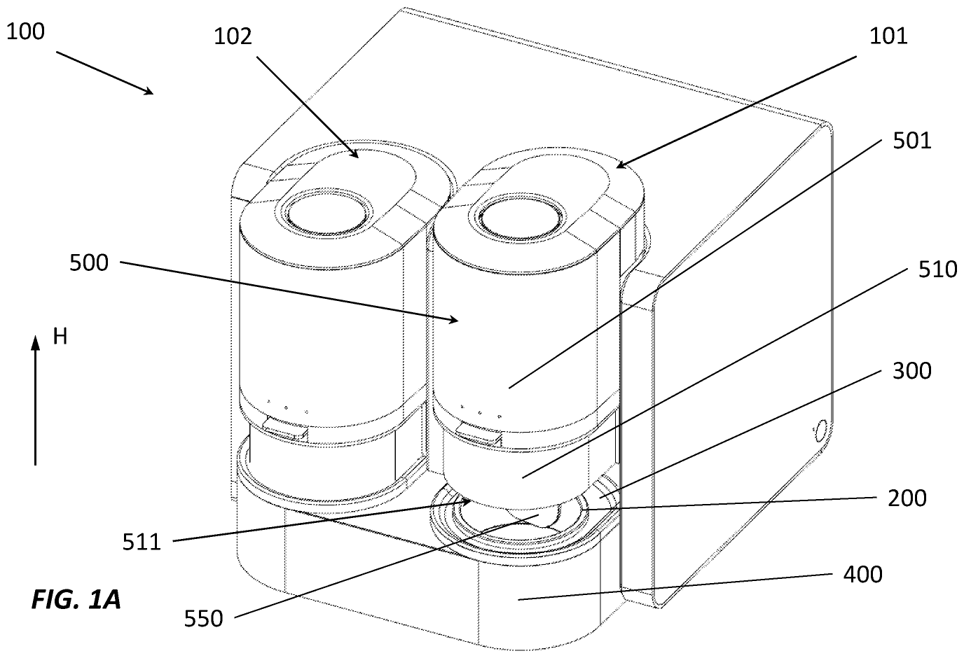

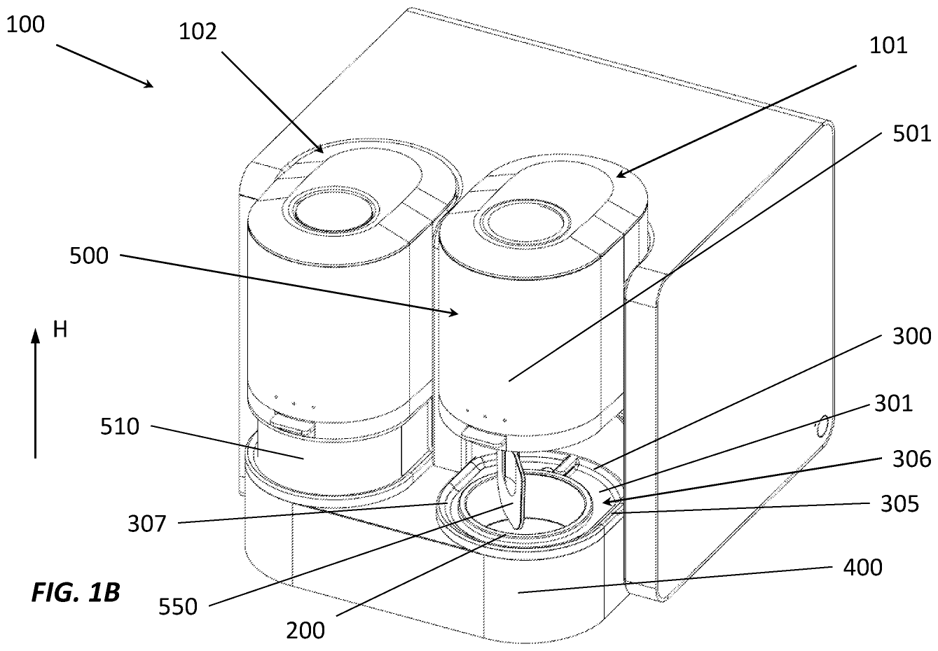

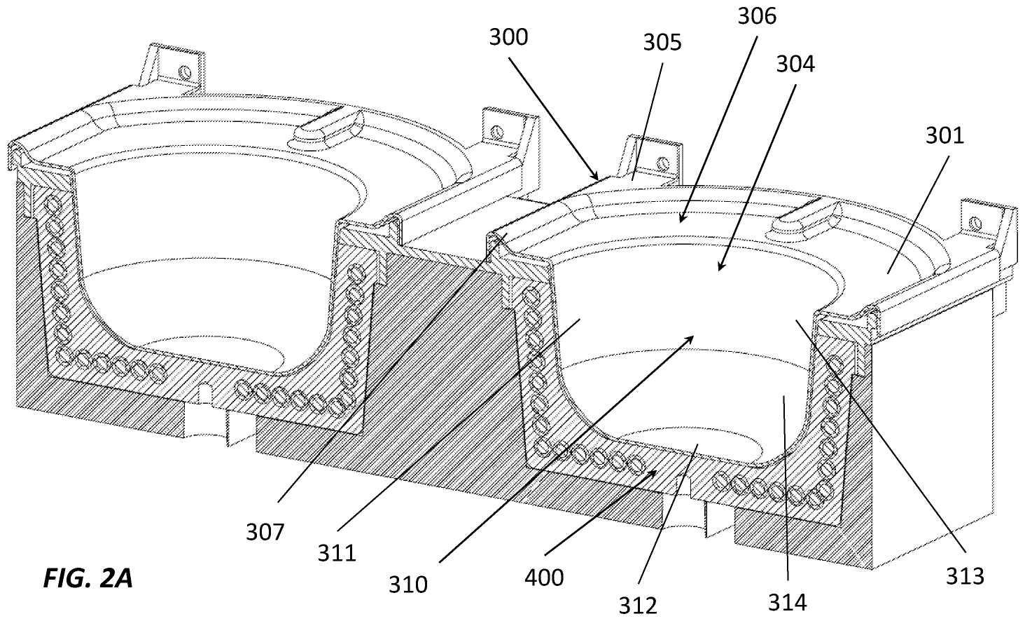

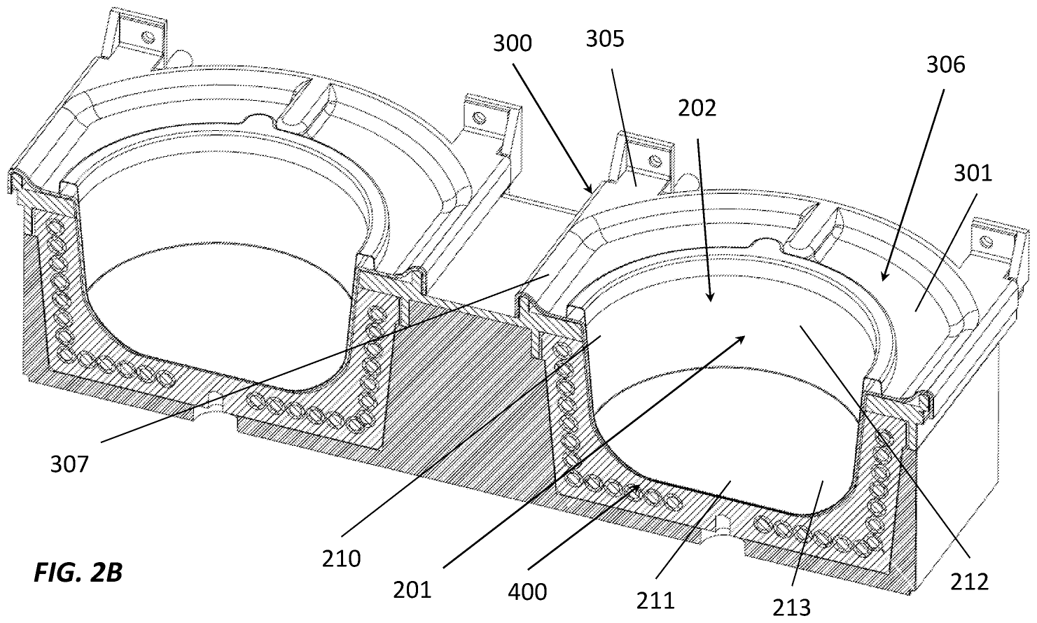

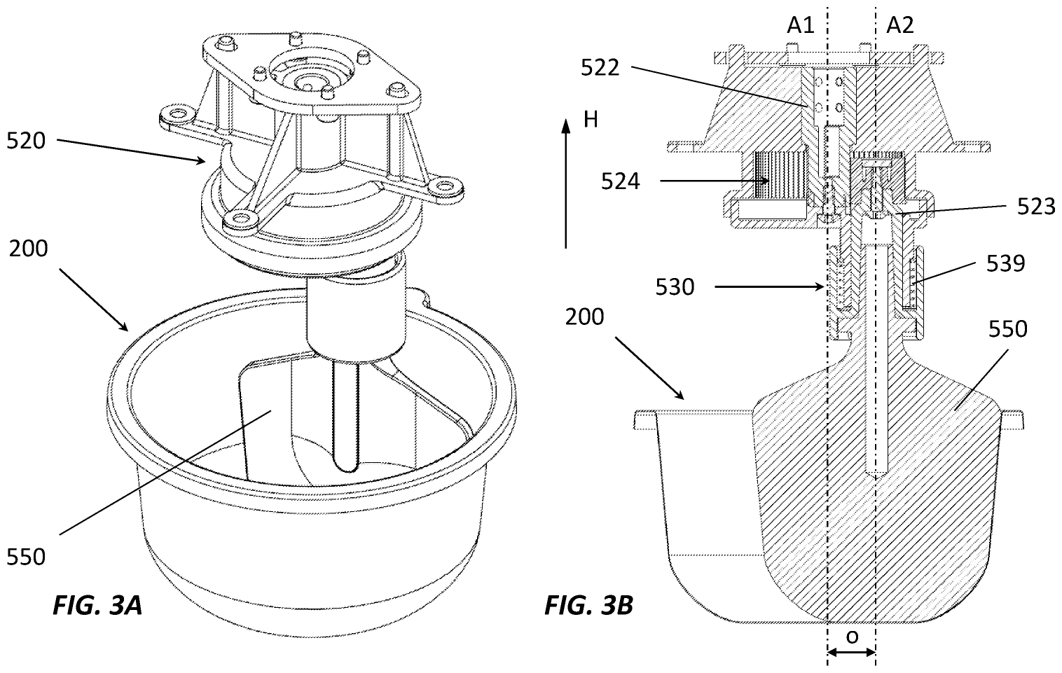

FIGS. 1A and 1B show a device 100 according to an embodiment of the present disclosure for preparing a frozen food product, such as for example ice cream or sorbet, from a liquid mixture. Further details of the device 100 are shown in the FIGS. 2A, 2B, 3A, 3B. 4A and 4B. The device 100 comprises a first sub-unit 101 which is arranged for preparing a frozen food product in a first cup 200, and a second sub-unit 102 which is arranged for preparing a frozen food product in a second cup 200, different from the first cup 200. The first sub-unit 101 and the second sub-unit 102 are arranged in a similar manner and operate independent from each other, such that two cups 200 of frozen food product can be prepared separate from each other. In alternative embodiments, the device 100 may comprise only a single sub-unit 101, 102, or may be provided with more than two of the sub-units 101, 102. Since the first sub-unit 101 and the second sub-unit 102 are arranged in similar manner, the features of the device 100 will be discussed below only with respect to one of the sub-units 101, 102.

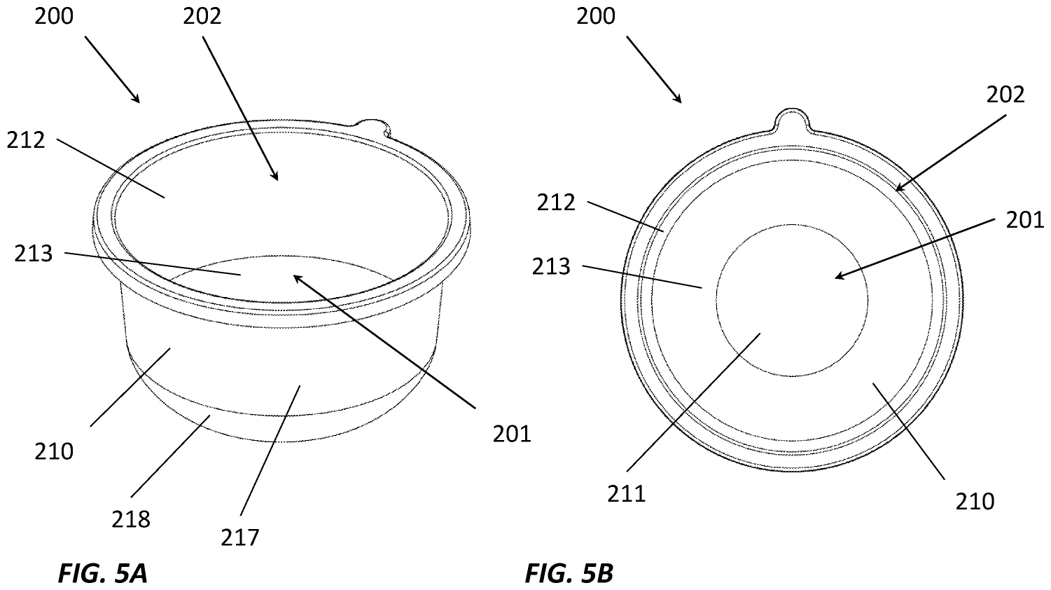

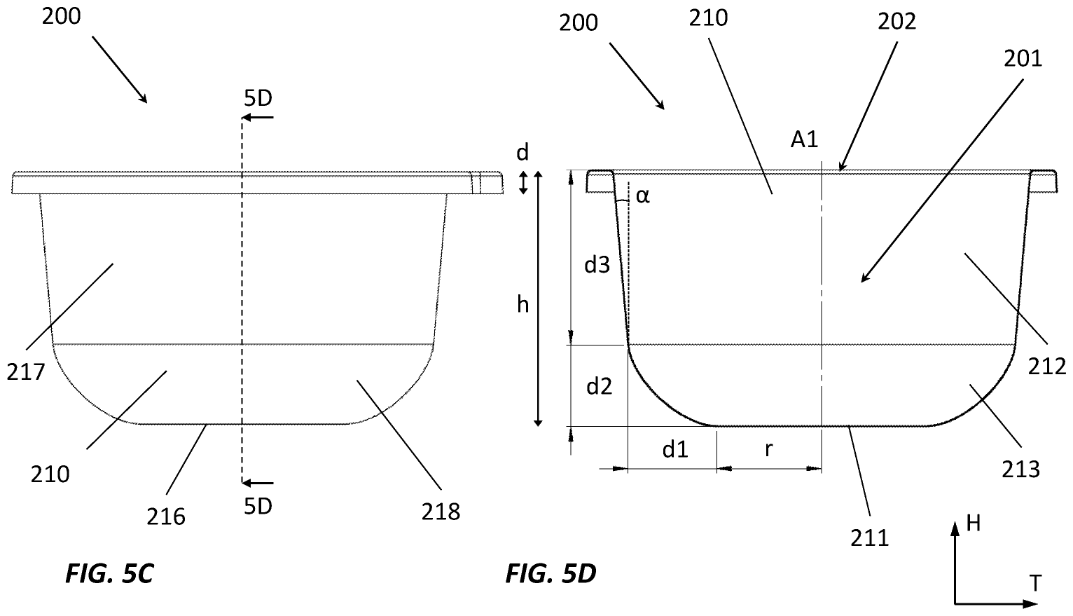

FIGS. 5A-5D show a cup 200 according to an embodiment of the present disclosure for use with the device 100. The cup 200 comprises a cup wall 210 which encloses a holding volume 201. The holding volume 201 is arranged for holding the liquid mixture therein, and also for holding the frozen food product therein after the frozen food product has been prepared form the liquid mixture. At the top, the cup 200 comprises a top opening 202 via which the holding volume 201 can be accessed. The cup 200 may be pre-filled with the liquid mixture, whereby the top opening 202 is sealed off by one or more sealing elements (not shown), such as a sealing membrane and a lid. The sealing elements can then be taken off the cup 200 before the cup 200 is to be used with the device 100. The cup 200 may also be a reusable cup 200, which is filled with a liquid mixture from a package pre-filled with liquid mixture or with a self-made liquid mixture right before the cup 200 is to be used with the device 100.

The device 100 comprises, as can be seen in FIGS. 1A and 1B and shown in more detail in FIGS. 2A and 2B, at its bottom a cup holder 300 which is arranged for holding the cup 200, preferably in a fixed position, while the frozen food product is being prepared in the cup 200. Therefore, the device 100 comprises a cavity 310 in which the cup 200 can be received via an entrance opening 304.

As can be seen for example in FIG. 2A, the entrance opening 304 of the cavity 310 is located in a first upper surface 301 of the cup holder 300. This first upper surface 301 is formed by a bottom surface 301 in a recessed area 306 in a second upper surface 305 of the cup holder 300. In this arrangement the second upper surface 305 is thus located above the first upper surface 301 in a height direction H. In alternative embodiments, the cup holder 300 can also be provided with a single flat first upper surface 301. The first upper surface 301 being located in the recessed area 306 is however advantageous for containing liquid mixture or frozen food product which is spilled accidentally out of the cup 200 in the recessed area 306, such that it is prevented from further spreading over the device 100.

The device 100 also comprises a cooling unit 400, as can be seen in FIGS. 1A and 1B and shown in more detail in FIGS. 2A and 2B. The cooling unit 400 is arranged for cooling the cavity 310 of the cup holder 300, and more specifically for cooling a cup 200 received in the cavity 310. The cooling unit 400 should be arranged to provide sufficient cooling for freezing liquid mixture contained in the cup 200 while preparing a frozen food product from the liquid mixture. The cooling unit 400 may comprise one or more cooling pipes, which are arranged around the cavity 310, and through which a cooling fluid is transported for cooling the cavity 310. The cooling unit 400 may however also be arranged in any other way know to the person skilled in the art for cooling the cavity 310 of a device 100 for preparing a frozen food product from a liquid mixture.

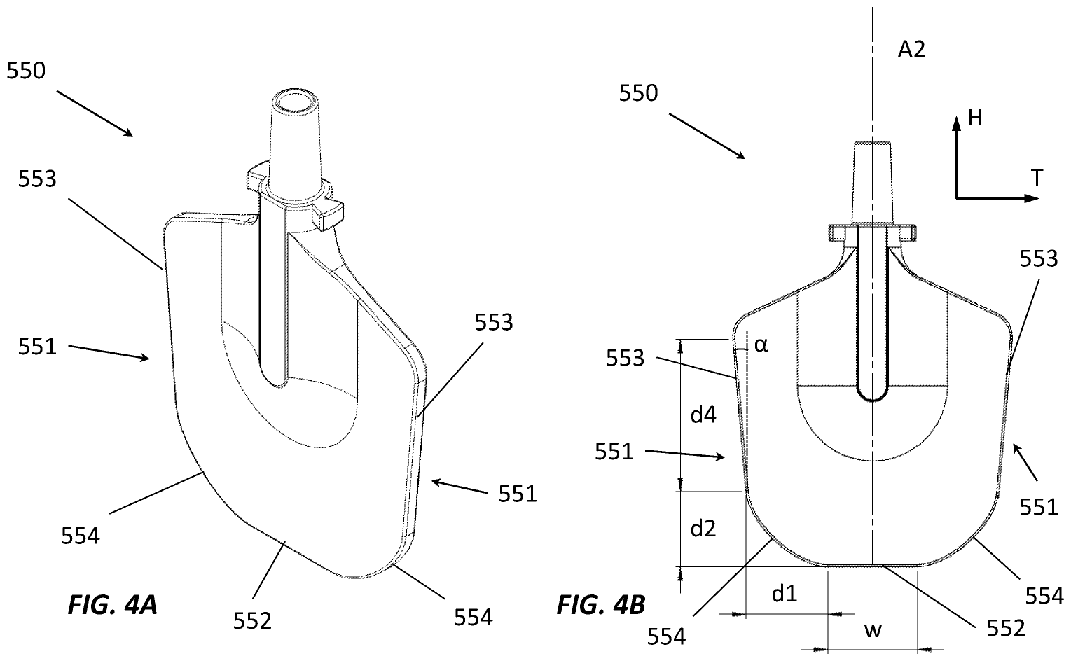

The device 100 also comprises a stirring unit 500 which is arranged above the cup holder 30), as can be seen in FIGS. 1A and 1B. The stirring unit 500 comprises a stirring element 550, which is shown in detail in FIGS. 4A and 4B. The stirring unit 500 is configured for stirring the liquid mixture in the cup 200 by said stirring element 550 for preparing the frozen food product. The stirring element 550 is removably connectable to the stirring unit 500, such that the stirring element 550 can be taken out of the device 100 for cleaning.

The stirring unit 500 comprises a moveable portion 501 which is moveable along a height direction H between a first position and a second position. In the first position, as shown for first sub-unit 101 of the device 100 in Figures IA and 1B, the stirring element 550 is arranged outside of the cup 200, such that it is easily accessible for disconnecting it from the stirring unit 500 for cleaning and for connecting it to the stirring unit 500. In the second position, as shown for the second sub-unit 102 of the device 100 in FIGS. 1A and 1B, the stirring element 550 is arranged inside the cup 200 such that the stirring unit 500 can stir the liquid mixture in the cup 200 by the stirring element 550 for preparing the frozen food product.

The stirring unit 500 is also provided with a protection screen 510, which is shown for both sub-units 101, 102 of the device 100 in FIG. 1A and for the second sub-unit in FIG. 1B. In FIG. 1B, the protection screen 510 has however been omitted for the first sub-unit 101 of the device 100, but only to show the features of the device 100 located behind the protection screen 510. The protection screen 510 extends downwards from the moveable portion 501 of the stirring unit 500, and moves together with the moveable portion 501 of the stirring unit 500. When the moveable portion 501 of the stirring unit 500 is in the second position, the protection screen 510 closes off an area located above the cup 200 and between the cup holder 300 and the moveable portion 501 of the stirring unit 500. This prevents access to the moving stirring element 550 when the frozen food product is being prepared, which is beneficial for safety. A further safety feature is that, in the second position of the moveable portion 501 of the stirring unit 500, the bottom edge 511 of the protection screen 510 supports on the first upper surface 301 near an edge 307 of the recessed area 306, such that it is difficult to get underneath the protection screen 510 and lift it up to gain access to the closed off area. The protection screen 510 is also beneficial for the cleanliness of the device 100, since it contains spilled liquid mixture or frozen food product in the closed off area, and prevents it from further spreading over the device 100.

The stirring unit 500 also comprises a drive system 520 for driving the stirring motion of the stirring element 550 in the cup 200, which drive system 520 is shown in detail in the FIGS. 3A and 3B. The drive system 520 comprises a motor (not shown) which is coupled to a first rotation shaft 522 for rotating the first rotation shaft 522. The first rotation shaft 522 is arranged in the height direction H along a first axis A1, which goes centrally through the cup 200 when received in the cavity 310 of the cup holder 300. The first rotation shaft 522 is connected to a secondary rotation shaft 523 by a planetary gear mechanism 524. The secondary rotation shaft 523 is arranged in the height direction H along a second axis A2, which goes centrally through the stirring element 550. The second axis A2 is located at a predetermined offset o from the first axis A1. The stirring element 550 is connected to the second rotation shaft 523 by a coupling mechanism 530. In this configuration, the motor rotating the first rotation shaft 522 causes the rotation of the stirring element 550 together with the second axis A2 around the first axis A1 and simultaneously the rotation of the stirring element 550 around the second axis A2. In alternative embodiments, other configurations of the drive mechanism may be used for rotating the stirring element 550, such as for example a drive mechanism with a single rotation shaft for rotating the stirring element 550 around a single axis.

The coupling mechanism 530 for connecting the stirring element 550 to the second rotation shaft 523 is provided with a spring 539 or other biasing element which is arranged for pushing the stirring element 550 downwards. This spring 539 causes the stirring element 550 to be pushed firmly against the cup 200 when the moveable portion 501 of the stirring unit 500 is in the second position, such that there is a good contact between the stirring element 550 and the cup 200 for scraping frozen liquid mixture from the cup wall 210 when frozen food product is being prepared from the liquid mixture in the cup 200.

The cup 200 according to an embodiment of the present disclosure will now be described in further detail. At the inside of the cup 200, as shown in FIG. 5D, the cup wall 210 comprises an inner bottom portion 211, a circumferential inner upright portion 212, and a circumferential inner transition portion 213 which extends between the inner bottom portion 211 and the inner upright portion 212 and as such connects the inner bottom portion 211 with the inner upright portion 212. At the outside of the cup 200, as shown for example in FIG. 5C, the cup wall 210 similarly comprises an outer bottom portion 211, a circumferential outer upright portion 212, and a circumferential outer transition portion 213. In the cup 200 shown the outer bottom portion 216, the outer upright portion 217 and the outer transition portion 218 have the same shape as respectively the inner bottom portion 211, the inner upright portion 212 and the inner transition portion 213, apart from the differences relating to the thickness of the cup wall 210. In alternative embodiments of the cup 200 according to the present disclosure, the shape of the outer bottom portion 216, the outer upright portion 217 and the outer transition portion 218 can however also be different from the shape of respectively the inner bottom portion 211, the inner upright portion 212 and the inner transition portion 213. The outer transition portion 218 may even be omitted, whereby the outer bottom portion 216 directly connects to the outer upright portion 217.

The cup 200 comprises several improvements with respect to cups for devices for preparing frozen food product from a liquid mixture known from the prior art. These improvements are mostly situated at the inside of the cup 200. Therefore, the discussion below will focus on the features of the cup wall 210 at the inside of the cup 200, whereas the features of the cup wall 210 at the outside of the cup 200 will only be discussed where necessary.

The inner bottom portion 211, the inner upright portion 212 and the inner transition portion 213 are cylindrically symmetric around the first axis A1. In this way, the stirring element 550 can contact the cup wall 210 at the inside of the cup 200, and remain in contact with the cup wall 210 when the stirring element 550 is being rotated around the first axis A1 for stirring liquid mixture in the cup 200. The stirring element 550 being in contact with the cup wall 210 at the inside of the cup 200 is beneficial for scraping frozen liquid mixture from the cup wall 200.

The inner bottom portion 211 is flat, which makes it easy to scoop frozen food product from this part of the cup wall 210 by a spoon, and which makes provides a simple contact surface for the stirring element to scrape frozen liquid mixture from when preparing the frozen food products. In alternative embodiments of the cup 200 according to the present disclosure the inner bottom portion 211 can however also have other shapes. The inner bottom portion has a radius r in the range from 16-26 mm, which is beneficial for providing a cup 200 for an individual portion of a frozen food product.

The inner transition portion 213 extends upwards from the inner bottom portion 211 in the height direction H, and has a radius of curvature R in the height direction H in the range from 15-25 mm. The radius of curvature R may be constant over the entire length of the inner transition portion 213 in the height direction H, such that the inner transition portion 213 is a circular arc in the height direction H. The radius of curvature R may however also be variable over the length of the inner transition portion 213 in the height direction H within the given range. Thereby, the inner transition portion 213 may for example be a parabolic arc or an elliptic arc in the height direction H. In some embodiments, the inner transition portion 213 is an elliptic arc which is less curved than a corresponding circular arc extending in the height direction H between the same inner bottom portion 211 and inner upright portion 212. The inner transition portion 213 having this shape beneficially adapts the curvature of the inner transition portion 213 to the curvature of the sides of a spoon, which makes it easier to scoop frozen food product from the inner transition portion 213 by a spoon.

The inner transition portion 213 extends in transverse or radial directions T, perpendicular to the height direction H, over a first distance d1 in the range from 15-25 mm. In the height direction H, the inner transition portion 213 extends over a second distance d2 in the range from 15-25 mm. The inner transition portion 213 extending over these distances d1, d2 beneficially adapts the size of the inner transition portion 213 to the size of a spoon, which makes it easier to scoop frozen food product from the inner transition portion 213 by a spoon. The size of the inner bottom portion 213 is also beneficial for providing a cup 200 for an individual portion of a frozen food product. In an embodiment of the cup 200 according to the present disclosure, the second distance d2 may be smaller than the first distance d1, in order to get a smooth transition between the inner transition portion 213 and the inclined inner upright portion 212, which will be described in more detail below.

The inner upright portion 212 is inclined with respect to the height direction H. Thereby, the inner upright portion 212 inclines outwards in the transverse directions T. The inner upright portion 212 has with respect to the height direction H an inclination angle α in the range from 1−9°, and preferably an inclination angle α of approximately 5°. The inclination angle α of the inner upright portion 212 being in this range is beneficial for preventing liquid mixture and frozen food product from spilling out of the cup 200 when the frozen food product is being prepared in the cup 200 by the stirring element 550 stirring the liquid mixture in the cup 200.

In the height direction H the inner upright portion 212 is straight to provide a simple surface to the stirring element 550 from which the stirring element 550 can easily scrape frozen food product when the frozen food product is being prepared in the cup 200 by the stirring element 550 stirring the liquid mixture in the cup 200. In alternative embodiments of the cup 200, the inner upright portion 212 may however also have other shapes in the height direction H with an average inclination angle α in the given range from 1−9°.

The inner upright portion 212 extends in the height direction H over a third distance d3 in the range from 32-42 mm, which beneficially provides in a sufficiently high inner upright portion 212 that aids in preventing liquid mixture and frozen food product from spilling out of the cup 200 when the frozen food product is being prepared in the cup 200 by the stirring element 550 stirring the liquid mixture in the cup 200. The inner upright portion 212 extending in the height direction over a third distance d3 in the given range is also beneficial for providing a cup 200 for an individual portion of a frozen food product.

For fittingly receiving the cup 200, the inner wall 311 of the cavity 310 of the cup holder 310, as can be seen in FIG. 2A, has a shape corresponding to the shape of the cup wall 210 at the outside of the cup 200, which as discussed above corresponds in this embodiment of the cup 200 to the shape of the cup wall 210 at the inside of the cup 200 apart from the differences relating to the thickness of the cup wall 210. Hence, in the inner wall 311 of the cavity 310 there can also be distinguished a flat bottom portion 312, a circumferential upright portion 313 and an circumferential transition portion 314 extending from the bottom portion 312 to the upright portion 313. Thereby, the outer upright portion 217 of the cup wall 210 and the upright portion 313 of the inner wall 311 of the cavity 310 being inclined outwards in transverse directions T from the height direction H offers the advantage that the cup 200 can easily be taken out of the cavity 310.

The stirring element 550 of the embodiment shown is a stirring paddle 550, as can be seen in the FIGS. 4A and 4B. The stirring element 550 is arranged to provide a good contact between with the cup wall 210 at the inside of the cup 200, as can be seen in FIG. 3B, such that the stirring element 550 is able to scrape frozen liquid mixture from the cup wall 210.

The stirring element 550, as can be seen in FIG. 4B, is symmetric with respect to the second axis A2 which goes centrally through the stirring element 550. The stirring element 550 comprises two edge sides 551 which are arranged opposite from each other in a transverse direction T perpendicular to the height direction H. Each edge side 551 comprises a bottom portion 552, an upright portion 553, and a transition portion 554 which extends between the bottom portion 552 and the upright portion 553 and as such connects the bottom portion 552 and the upright portion 553. In the stirring element 550 shown both edge sides 551 share the same bottom portion 552. To provide the good contact between the stirring element 550 and the cup wall 210 at the inside of the cup 200 the bottom portion 552, the upright portion 553 and the transition portion 554 of both edge sides 551 of the stirring element 550 are given a shape which corresponds to the shape of respectively the inner bottom portion 211, the inner upright portion 212 and the inner transition portion 213 of the cup wall 210.

The bottom portion 552 of the edge sides 551 is flat in correspondence with the flat inner bottom portion 211 of the cup wall 210 of the cup 200. The bottom portion 552 of the edges sides 551 has a width w over which it extends in the transverse direction T. In this embodiment the width w is chosen to be equal to the radius r of the inner bottom portion 211 of the cup wall 210 in range from 16-26 mm. With such a width w the bottom portion 552 of the edge sides 551 extends from the circumference right up to the centre of the inner bottom portion 211 of the cup wall 210, such that when the stirring element 550 is rotated around the first axis A1 frozen liquid mixture is scraped from the entire inner bottom portion 211 of the cup wall 210 by the stirring element 550. In this configuration, the edge sides 551 also come alternatingly in contact with the cup wall 210 of the cup 200 when the stirring element 500 is rotated around the second axis A2.

The transition portion 554 of the edge sides 551 of the stirring element 550 is in the height direction H an elliptic, circular or parabolic arc with a radius of curvature R in the range from 15-25 mm, such as the inner transition portion 213 of the cup wall 210 of the cup 200. Thereby, the transition portion 554 of the edge sides 551 of the stirring element 550 extends in the transverse direction T and in the height direction H over respectively the same first distance d1 and second distance d2 in the range from 15-25 mm as the inner transition portion 213 of the cup wall 210 of the cup 200.

The upright portion 553 of the edge sides 551 of the stirring element 550 is straight in the height direction H, and is inclined outwards in the transverse direction T from the height direction H. Thereby, the upright portion 553 of the edge sides 551 of the stirring element have with respect to the height direction H the same inclination angle α in the range from 1−9° as the inner upright portion 212 of the cup wall 210 of the cup 200. The upright portion 553 of the edge sides 551 of the stirring element 550 extend in the height direction H over a fourth distance d4 in the range from 32-42 mm. In some embodiments, the fourth distance d4 is equal to the third distance d3 over which the inner upright portion 212 of the cup wall 210 of the cup 200 extends in the height direction H. This has the advantage that frozen liquid mixture is scraped from the entire inner upright portion 212 of the cup wall 210 by the stirring element 550 when the stirring element 550 is rotated around in the cup 200. In alternative embodiments, the fourth distance d4 may however also be smaller or larger than the third distance d3.

### REFERENCES

100 device
101 first sub-unit
102 second sub-unit
200 cup
201 holding volume
202 top opening
210 cup wall
211 inner bottom portion
212 inner upright portion
213 inner transition portion
216 outer bottom portion
217 outer upright portion
218 outer transition portion
300 cup holder
301 first upper surface
304 entrance opening
305 second upper surface
306 recessed area
307 edge
310 cavity
311 inner wall
312 bottom portion
313 upright portion
314 transition portion
400 cooling unit
500 stirring unit
501 moveable portion
510 protection screen
511 bottom edge
520 drive system
522 first rotation shaft
523 second rotation shaft
524 planetary gear mechanism
530 coupling mechanism
539 spring
550 stirring element
551 edge side
552 bottom portion
553 upright portion
554 transition portion
A1 first axis
A2 second axis
offset
H height direction
T transverse direction
R radius of curvature
a inclination angle
d1 first distance
d2 second distance
d3 third distance
d4 fourth distance
w width
r radius

1. A cup for a device for preparing a frozen food product from a liquid mixture, wherein the cup is arranged for preparing the frozen food product therein from the liquid mixture with a stirring element of the device stirring the liquid mixture in the cup while the cup is being cooled with a cooling unit of the device, wherein the cup comprises a cup wall enclosing a holding volume for the liquid mixture and the frozen food product, wherein the cup comprises a top opening to the holding volume, wherein, at an inside of the cup, the cup wall comprises an inner bottom portion, a circumferential inner upright portion, and a circumferential inner transition portion extending from the inner bottom portion to the inner upright portion, wherein the inner bottom portion, the inner upright portion and the inner transition portion are cylindrically symmetric around a first axis centrally through the inner bottom portion and extending along a height direction, wherein the inner transition portion has in the height direction a radius of curvature of at least 15 mm and of at most 25 mm, wherein the inner upright portion is inclined outwards in a transverse direction from the height direction, and wherein the inner upright portion has with respect to the height direction a predetermined inclination angle of at least 1° and of at most 9°.

2. The cup according to claim 1, wherein the inner bottom portion is flat.

3. The cup according to claim 1, wherein the inner bottom portion has a predetermined radius of at least 16 mm and of at most 26 mm.

4. The cup according to claim 1, wherein the inner transition portion is in the height direction one of an elliptic arc, a circular arc, and a parabolic arc.

5. The cup according to claim 1, wherein the inner transition portion extends in the transverse direction over a predetermined first distance of at least 15 mm and of at most 25 mm.

6. The cup according to claim 1, wherein the inner transition portion extends in the height direction over a predetermined second distance of at least 15 mm and of at most 25 mm.

7. The cup according to claim 1, wherein the inner upright portion extends in the height direction over a predetermined third distance of at least 32 mm and of at most 42 mm.

8. The cup according to claim 1, wherein the inner upright portion is straight in the height direction.

9. A stirring element for a device for preparing a frozen food product from a liquid mixture, wherein the stirring element is arranged for preparing the frozen food product by stirring the liquid mixture in a cup of the device while the cup is being cooled with a cooling unit of the device, wherein the stirring element comprises at least one edge side, wherein the at least one edge side comprises a bottom portion, an upright portion, and a transition portion extending from the bottom portion to the upright portion, wherein the transition portion has a radius of curvature of at least 15 mm and of at most 25 mm, wherein the upright portion is inclined outwards in a transverse direction from a height direction, and wherein the upright portion has with respect to the height direction a predetermined inclination angle of at least 1° and of at most 9°.

10. The stirring element according to claim 9, wherein the bottom portion is flat.

11. The stirring element according to claim 9, wherein the bottom portion has a predetermined width of at least 16 mm and of at most 26 mm.

12. The stirring element according to claim 9, wherein the transition portion is in the height direction one of an elliptic arc, a circular arc and a parabolic arc.

13. The stirring element according to claim 9, wherein the transition portion extends in the transverse direction over a predetermined first distance of at least 15 mm and of at most 25 mm.

14. The stirring element according to claim 9, wherein the transition portion extends in the height direction over a predetermined second distance of at least 15 mm and of at most 25 mm.

15. The stirring element according to claim 9, wherein the upright portion extends in the height direction over a predetermined fourth distance of at least 32 mm and of at most 42 mm.

16. The stirring element according to claim 9, wherein the stirring element comprises a first edge side and a second edge side, wherein the first edge side and the second edge side are arranged opposite of each other in the transverse direction.

17. A device for preparing a frozen food product from a liquid mixture, the device comprising:
a cup in which the frozen food product is to be prepared from the liquid mixture, wherein the cup comprises a cup wall enclosing a holding volume for the liquid mixture and the frozen food product, wherein the cup comprises a top opening to the holding volume, wherein, at an inside of the cup, the cup wall comprises an inner bottom portion, a circumferential inner upright portion, and a circumferential inner transition portion extending from the inner bottom portion to the inner upright portion, wherein the inner bottom portion, the inner upright portion and the inner transition portion are cylindrically symmetric around a first axis centrally through the inner bottom portion and extending along a height direction, wherein the inner transition portion has in the height direction a radius of curvature of at least 15 mm and of at most 25 mm, wherein the inner upright portion is inclined outwards in a transverse direction from the height direction, and wherein the inner upright portion has with respect to the height direction a predetermined inclination angle of at least 1° and of at most 9°;
a cup holder comprising a cavity receiving the cup;
a cooling unit configured for cooling the cavity of the cup holder; and
a stirring unit configured for stirring the liquid mixture in the cup with a stirring element for preparing the frozen food product, wherein the stirring element comprises at least one edge side, wherein the at least one edge side comprises a bottom portion, an upright portion, and a transition portion extending from the bottom portion to the upright portion, wherein the transition portion has the radius of curvature of at least 15 mm and of at most 25 mm, wherein the upright portion is inclined outwards in a transverse direction from the height direction, and wherein the upright portion has with respect to the height direction the predetermined inclination angle of at least 10 and of at most 9°, wherein the stirring unit comprises a drive system for driving the stirring motion of the stirring element in the cup.

18. The device according to claim 17, wherein an inner wall of the cavity comprises a circumferential upright portion, wherein the upright portion has with respect to a height direction the predetermined inclination angle of at least 1° and of at most 9°.

19. The device according to claim 17, wherein the stirring element is arranged with a second axis in a height direction through the stirring element at a predetermined offset from the first axis, and wherein the drive system is arranged for rotating the stirring element around the first axis and the second axis.

20. The device according to claim 17, wherein the cup holder comprises a first upper surface surrounding an entrance opening of the cavity, wherein the cup holder comprises in a second upper surface a recessed area surrounding the entrance opening of the cavity, wherein a bottom surface of the recessed area forms the first upper surface of the cup holder, wherein the stirring unit is arranged above the cup holder, and wherein the stirring unit comprises a moveable portion which is moveable along a height direction between a first position wherein the stirring element is arranged outside of the cup and a second position wherein the stirring element is arranged inside the cup for stirring the liquid mixture for preparing the frozen food product, wherein the stirring unit is provided with a protection screen extending downwards from the moveable portion of the stirring unit, wherein the protection screen is arranged such that a bottom edge of the protection screen supports on the first upper surface when the moveable portion of the stirring unit is in the second position.
